(19) United States
(12) Patent Application Publication
(10) Pub. No.: US 2010/0079923 A1
(43) Pub. Date: Apr. 1, 2010

(54) MULTI-FUNCTION CIRCUIT INTERRUPTION ACCESSORY

(75) Inventor: Pradeep Kumar Anand, Hyderabad (IN)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/241,929

(22) Filed: Sep. 30, 2008

(51) Int. Cl. H01H 47/00

(52) U.S. Cl. 361/152

(57) ABSTRACT

A protection apparatus for a circuit breaker disposed in a circuit to be protected uses a solenoid configured to operate the circuit breaker on command, an undervoltage release (UVR) sensing apparatus configured to produce an UVR signal in response to a line voltage of the circuit to be protected falling below a predetermined level, and a shunt trip (ST) sensing apparatus configured to produce a ST signal when it senses a ST command. A controller operably connected to the UVR sensing apparatus, the ST sensing apparatus, and the solenoid, is configured to receive the UVR and ST signals when produced and controls the solenoid to open the breaker in response to receipt by the controller of either of the UVR and ST signals.

### BACKGROUND

Embodiments of the invention disclosed herein relate to circuit interruption devices that protect electrical equipment. In particular, embodiments of the invention relate to shunt trip and undervoltage release accessories for circuit breakers.

A shunt trip (ST) device, used to open a remote circuit breaker, and an under voltage release (UVR) device, used to protect the circuit in which the circuit breaker is present from a low voltage condition, are two available accessories for a circuit breaker. Currently, a separate accessory is required for each of the ST and LVR devices in a circuit breaker, each one having their own housings, their own electronics, and their own separate solenoids. Many users opt for both ST and UVR that many circuit breakers become crowded, more expensive, and more complicated.

Though both ST and TVR open a breaker using solenoids, UVR solenoids are maintained in an on state until line voltage goes below a predetermined minimum level, whereas ST solenoids are kept off until they are needed to open the breaker. Thus, while there is a need for a combined ST and LVR accessories for a circuit breaker, there are obstacles to doing so that must be overcome.

### BRIEF DESCRIPTION

In an embodiment, a protection apparatus for a circuit breaker disposed in a circuit to be protected uses a solenoid configured to operate the circuit breaker on command, an undervoltage release (UVR) sensing apparatus configured to produce an UVR signal in response to a line voltage of the circuit to be protected falling below a predetermined level, and a a shunt trip (ST) sensing apparatus configured to produce a ST signal when it senses a ST command. A controller operably connected to the TVR sensing apparatus, the ST sensing apparatus, and the solenoid, is configured to receive the UVR and ST signals when produced and controls the solenoid to open the breaker in response to receipt by the controller of either of the UVR and ST signals.

According to features of embodiments, a protection apparatus for a circuit breaker disposed in a circuit to be protected includes a solenoid configured to open the circuit breaker on command and a controller connected to the solenoid and configured to issue an open command to the solenoid in response to receipt of either of an UVR signal and a ST signal. An UVR sensing apparatus is configured to be connected to a line conductor of the circuit to be protected and to monitor a line voltage of the circuit to be protected when such a voltage is carried by the line conductor. The UVR sensing apparatus produces an UVR signal in response to the line voltage falling below a predetermined level and sends the signal to the controller. A ST sensing apparatus is configured to monitor for a ST command and to produce a ST signal and send it to the controller in response to sensing a ST command.

A circuit breaker accessory shunt trip (ST) and undervoltage voltage release (UVR) method of embodiments includes providing a solenoid configured and disposed to activate an operating mechanism of a circuit breaker in response to current in the solenoid falling below a predetermined level. The method continues by providing a microprocessor configured and disposed to selectively control current flow to the solenoid, monitoring the circuit for UVR states and for ST states, and selectively controlling current flow to the solenoid with the microprocessor in response to an undervoltage release state and in response to a shunt trip state.

### BRIEF DESCRIPTION OF THE DRAWINGS

FIG. 1 shows a schematic block diagram of an apparatus according to an embodiment disclosed herein.

FIG. 2 shows a schematic block diagram of an apparatus according to an embodiment disclosed herein.

FIG. 3 shows a schematic flow diagram of a method according to an embodiment disclosed herein.

### DETAILED DESCRIPTION

With reference to the accompanying Figures, examples of an apparatus and method according to embodiments disclosed herein are shown. For purposes of explanation, numerous specific details are shown in the drawings and set forth in the detailed description that follows in order to provide a thorough understanding of embodiments of the present invention. It will be apparent, however, that embodiments of the present invention may be practiced without these specific details. In other instances, well-known structures and devices are schematically shown in order to simplify the drawing.

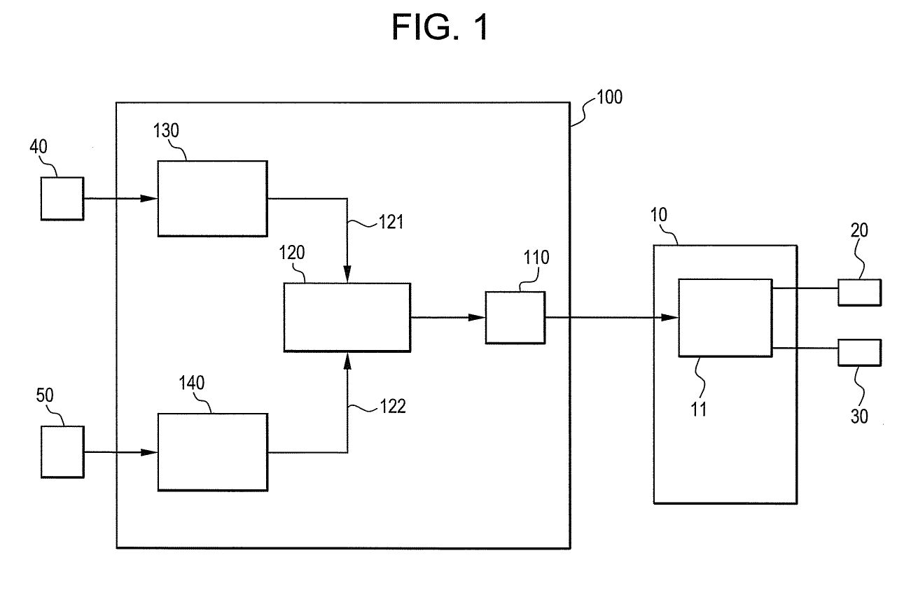

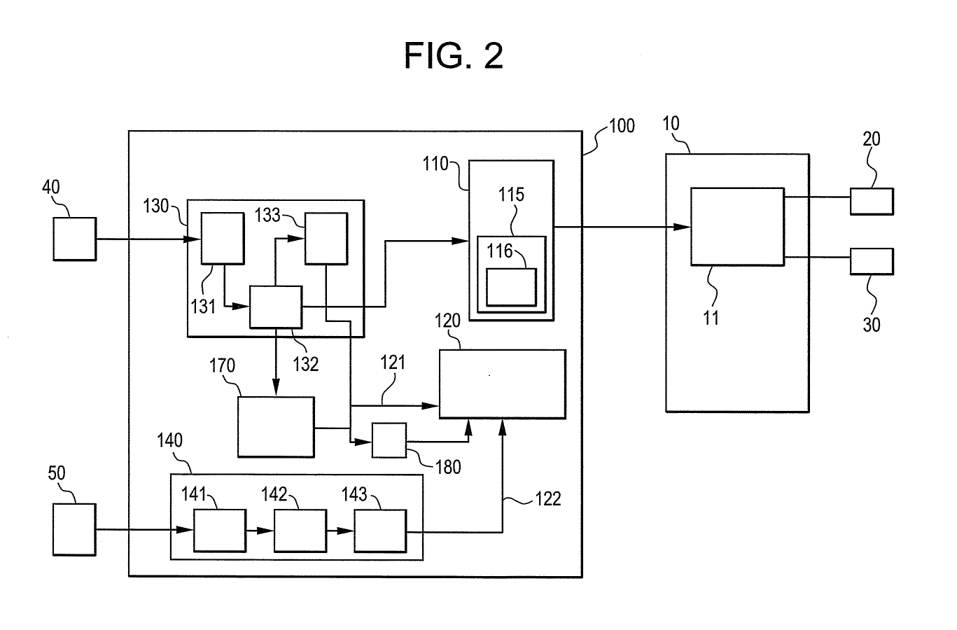

In FIG. 1, a combined shunt trip and undervoltage protection apparatus 100 has a solenoid 110 disposed and configured to operate a mechanism 11 of a circuit interruption device or circuit breaker 10 in a circuit to be protected. The breaker 10 is situated between a line conductor 20 and a load conductor 30 to selectively provide a connection between line and load. The connection is made between first and second contacts moved into and out of engagement with each other by the mechanism 11. Typically, one of the first and second contacts is fixed and the other is movable, but embodiments can be used with breakers that employ a pair of contacts where both are movable, or may employ more than one pair of contacts, such as in a double-break system, as long as the solenoid 110 can operate the mechanism 11. One type of solenoid 110 that can be used in embodiments is that typically used for undervoltage release accessories in which current flowing through the coil of the solenoid at a line voltage above a predefined threshold, known as the “drop-out threshold,” holds the solenoid in a position such that the breaker remains closed. When the line voltage drops below the drop-out threshold, the solenoid changes to a position such that the breaker opens. Typically, when the solenoid is open the circuit breaker is permitted to be closed, thereby permitting circuit breaker operation when the line voltage is at an acceptable level, i.e. above the drop-out threshold, and when the solenoid closes, it opens the breaker. UVR accessories can instead be arranged so that when the solenoid is closed, the breaker is closed, and when the solenoid opens in response to line voltage falling below the predefined voltage, the breaker opens. Alternatively, a simple solenoid can be used that will open the breaker when activated. In the example shown in FIG. 2, an embodiment employs a solenoid driver 115 responsive to the controller 120 to selectively control current flowing through the solenoid 110. Depending on the particular type of solenoid employed, the solenoid driver 115 will provide a current proportional to line voltage when a line voltage is present or will simply switch current on or off in response to a command from the controller 120.

In embodiments, therefore, the solenoid 110 is a hold open type solenoid that includes a bias tending to close the solenoid. When current is supplied to the solenoid 110 above a level corresponding to a pick-up threshold voltage, the force generated by the solenoid coil overcomes the bias and the solenoid opens. Once the solenoid is open, a lower current level and corresponding voltage is required to hold it open and it will remain open until the current drops below the solenoid's drop-out threshold and the voltage drops below the corresponding drop-out voltage. It is therefore sufficient to selectively control current to the solenoid 110 by reducing current in the solenoid below this drop-out threshold level, but embodiments stop current to the solenoid 110 for simplicity. An example, therefore, of a suitable solenoid driver 115 includes a metal oxide semi-conductor field effect transistor (MOSFET) driver circuit 116 with which the controller 120 reduces current to the solenoid 110 by turning off the MOSFET.

The solenoid 110 is responsive to a controller 120 that produces a control signal for the solenoid 110 in response to an UVR signal 121 indicating that an UVR state exists or a ST signal 122 indicating that a ST state exists. As used herein, “UVR” and “undervoltage release” refer to the opening of the breaker 10 when the monitored voltage drops below the predetermined level, and “UVR state” and “undervoltage release state” refer to a state in which there is a need for UVR. An UVR state exists when line voltage has dropped below a predetermined level—the drop-out threshold discussed above. Also as used herein, “ST” and “shunt trip” refer to opening of the breaker in response to a command, local or remote, to do so, generated by software and hardware automatically, by initiation of the command by a user using software and/or computer hardware, by activation of a switch in a remote location, or by activation of a switch locally. The command can be carried in any suitable manner, such as by a signal over the line or load conductor, by a signal via a communications network, or by a direct connection to the controller from a switch. “ST state” and “shunt trip state” refer to a state in which an ST command as been sensed or detected, such as when a user has activated a switch to open the breaker or when a command has otherwise been issued over a conductor or via a communication network or the like.

The UVR signal 121 is produced by an UVR detecting or sensing apparatus 130 in an embodiment. The UVR sensing apparatus 130 is operably connected to the controller 120 and in the embodiment shown in the FIGS. is operably connected to a conductor 40 so that it can monitor and respond to a voltage when a voltage is carried by the conductor 40. In the embodiment shown, the conductor 40 carries a line voltage of the circuit to be protected. The UVR sensing apparatus 130 produces the UVR signal 121 indicative of an undervoltage release state in response to a drop in the monitored voltage below the predetermined level. In the example shown in FIG. 2, an embodiment includes a filter circuit 131 connected to the conductor 40 and to a rectifier circuit 132. The rectifier circuit 132 sends rectified output to an UVR voltage sensing circuit 133, which provides the UVR signal 121 to the controller 120 indicative of an UVR state or event when the monitored voltage drops below the predetermined level. The rectifier circuit 132 also provides power to the solenoid 110.

The ST signal 122 is produced in embodiments by a ST detecting or sensing apparatus 140 configured to be connected to a conductor 50 and responsive to an ST command when a command is carried in the conductor 50. In embodiments, the conductor 50 is connected to a switch, such as a remote or local button, so that when a user activates the switch, such as by pushing a button, the ST command is sent through the conductor 50 and the ST sensing apparatus generates the ST signal 122. Alternatively, as particularly seen in FIG. 2, the conductor 50 can be configured to carry a voltage, such as a line voltage, to which the ST detecting apparatus is responsive. In such an embodiment, the ST command can be issued as a signal that is part of the line voltage. For example, in the example shown, an embodiment includes a voltage spike or transient protection circuit 141, such as a metal oxide varistor (MOV), connected to a ST rectifier circuit 142. The ST rectifier circuit 142 sends rectified output to a ST voltage and isolation circuit 143 that provides the ST state or event signal 122 to the controller 120 when a ST command has been sensed. By virtue of the transient protection circuit 141, ST rectifier circuit 142, and ST voltage and isolation circuit 143, the ST detecting or sensing apparatus 140 is usable with AC or DC line voltages.

It should be understood that the controller 120 could be directly responsive to a ST command carried via other ST command bearing media. Examples of other media include a communications network, such as TCP/IP (Transmission Control Protocol/Internet Protocol), Ethernet, IEEE 802.11x wireless, Token Ring, Bluetooth, IR, telephone, satellite, and cellular telephone networks, but could also take the form of a direct wired or wireless connection between the command-issuing device and the controller 120, such as RS-232, ModBus, and other connections. The ST command could even be delivered by a switch or other input device provided as part of the breaker.

The combined UVR and ST accessory apparatus in the embodiment shown in FIG. 2 also includes a power supply 170 that receives power from the rectifier circuit 132 and provides power to the controller 120. A brownout protection circuit 180 is also connected to the power supply 170 and the controller 120 to reset the controller 120 when voltage drops below a predetermined level.

A controller 120 is connected to the UVR sensing apparatus 130 and responds to a UVR signal 121 from the UVR sensing apparatus 130 produces to detect the UVR state. The controller 120 is also connected to the ST sensing apparatus 140 and responds to the ST signal to detect the ST state. In an embodiment, the controller 120 is a microprocessor responsive to computer executable instructions which, when executed on the microprocessor, monitor the connections to the UVR and ST sensing apparatus and determine that a UVR state exists or that a ST state exists in response to respective UVR and ST signals 121, 122. The controller 120 responds to one of the UVR and ST states by controlling the solenoid 110, such as by selectively controlling current to the solenoid 110, so that it activates the mechanism 11. In embodiments in which the solenoid 110 is an UVR type or hold open solenoid, the controller 120 is a microprocessor programmed to selectively control current to the solenoid 110 by reducing current to the solenoid 110 below the drop-out threshold current in response to a UVR or ST state, which causes tripping of the breaker 10. To reduce current to the solenoid 110 and cause tripping of the breaker 10 in the example shown in FIG. 2, the controller 120 sends commands to the solenoid driver 115, the solenoid driver 115 being responsive to the controller 120 to modify current flowing to the solenoid 110. When the solenoid driver 115 includes a MOSFET 116, the controller 120 turns the MOSFET off in response to a UVR or ST state, which stops current to the solenoid 110, which trips the breaker 10.

While the controller 120 has been described in the example embodiment as a microprocessor, it can be any suitable electronic device that can receive data and instructions, execute the instructions to process data, and present results. The controller 120 can also be, but is limited to, a microcomputer, a minicomputer, an optical computer, a board computer, a complex instruction set computer, an application specific integrated circuit, a reduced instruction set computer, an analog computer, a digital computer, a solid-state computer, a single-board computer, or a combination of any of these. Instructions can be delivered to the controller 120 via electronic data card, voice activation, manual selection and control, electromagnetic radiation, and electronic or electrical transfer.

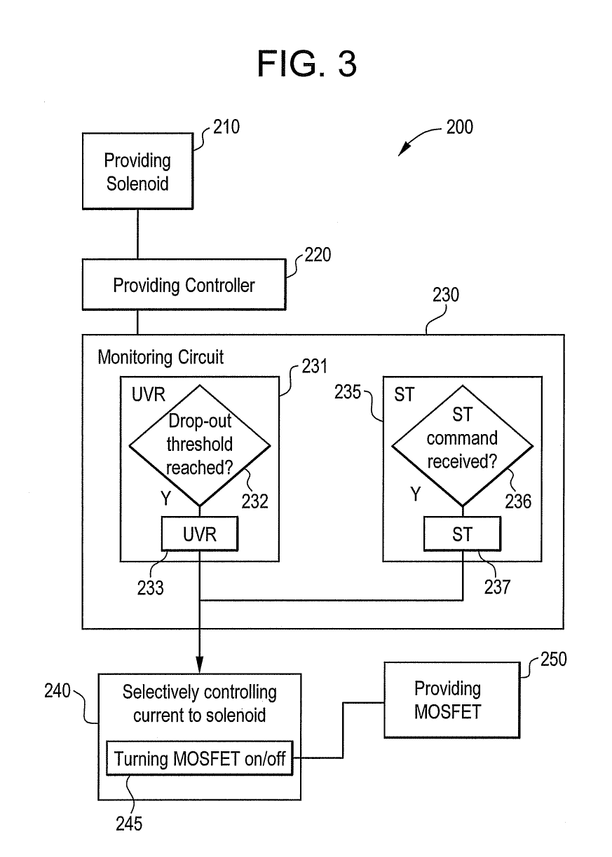

In FIG. 3, a shunt trip and undervoltage voltage release method 200 is shown schematically and is written in computer instructions executable by the controller, such as in the form of software encoded in any programming language. Examples of suitable programming languages include, but are not limited to, assembly language, VHDL (Verilog Hardware Description Language), Very High Speed IC Hardware Description Language (VHSIC HDL), FORTRAN (Formula Translation), C, C++, C#, Java, ALGOL (Algorithmic Language), BASIC (Beginner All-purpose Symbolic Instruction Code), APL (A Programming Language), ActiveX, HTML (HyperText Markup Language), XML (eXtensible Markup Language), and any combination or derivative of one or more of these. The method begins with providing a solenoid 210 arranged to activate an operating mechanism of a circuit breaker when current in the solenoid stops. The method also includes providing a controller 220, such as a microprocessor, electrically connected to the solenoid and that will selectively control current flow to the solenoid. By monitoring the circuit for undervoltage and shunt states 230, the method enables selectively controlling current flow to the solenoid 240 when an undervoltage release is required, as well as selectively controlling current flow to the solenoid 240 when a shunt trip is required. As discussed above, selectively controlling current flow in embodiments comprises reducing current flow below the drop-out threshold current of the solenoid. This can be done by manipulating the current or by reducing the voltage across the solenoid below the corresponding drop-out threshold voltage. In particular, embodiments stop current flow to the solenoid for simplicity. Monitoring the circuit 230 includes, for example, monitoring a voltage of the circuit, such as a line voltage or a phase voltage, for an UVR state 231. Monitoring the circuit 230 also includes monitoring a voltage, such as a line voltage, for a ST command 235.

As seen in the embodiment shown in FIG. 3, monitoring a voltage for an TVR state 231 includes comparing the monitored voltage to a predetermined minimum voltage 232, determining that an UVR is required 233 when the voltage is less than the predetermined minimum voltage, and sending a signal to the controller that a UVR state exists. When embodiments include providing a MOSFET 250 electrically connected to the controller, selectively controlling current flow to the solenoid 240 comprises turning the MOSFET on and off 245. In particular, selectively controlling current flow comprises reducing current flow below a drop-out threshold of the solenoid. For simplicity, this is done in embodiments by stopping current flow, such as by turning the MOSFET off.

As also seen in the embodiment shown in FIG. 3, monitoring the circuit for a ST state 235 includes determining that a shunt trip command has been detected 236. The command will have been issued by a remote unit and can take the form of a voltage signal on the line voltage, but other signal forms can be employed, such as via a wired or wireless computer network and other media as discussed above. If a ST command has been detected, then an ST is required 237 and the method proceeds by sending a signal that a ST state is present to the controller. As above, when embodiments include providing a MOSFET 250 electrically connected to the controller, selectively providing current to the solenoid 240 comprises turning the MOSFET on and off 245. In particular, selectively controlling current flow to the solenoid comprises stopping current flow, such as by turning the MOSFET off.

Employing the combined ST and UVR accessory of embodiments reduces by half the amount of space required as compared to having separate ST and UVR accessories. In addition, because of shared components, costs and complexity are reduced by half, resulting in a less expensive, simpler breaker accessory. Reduced complexity can also result in increased reliability.

An embodiment of the invention can take the form of computer-implemented processes and apparatus for practicing such processes. Additionally, an embodiment can take the form of a computer program product including computer code, such as object code, source code, or executable code, on tangible media, such as magnetic media (floppy diskettes, hard disc drives, tape, etc.), optical media (compact discs, digital versatile/video discs, magneto-optical discs, etc.), random access memory (RAM), read only memory (ROM), flash ROM, erasable programmable read only memory (EPROM), or any other computer readable storage medium on which the computer program code is stored and with which the computer program code can be loaded into and executed by a computer. When the computer executes the computer program code, it becomes an apparatus for practicing the invention, and on a general purpose microprocessor, specific logic circuits are created by configuration of the microprocessor with computer code segments. A technical effect of the executable instructions is to use a single solenoid to open the breaker in response to both an UVR state of a circuit in which a circuit breaker is installed and a ST state, such as receiving a ST command.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

1. A protection apparatus for a circuit breaker disposed in a circuit to be protected, comprising:
a solenoid configured to operate the circuit breaker on command;
an undervoltage release (UVR) sensing apparatus configured to produce an UVR signal in response to a line voltage of the circuit to be protected falling below a predetermined level;
a shunt trip (ST) sensing apparatus configured to produce a ST signal when it senses a ST command;
a controller operably connected to the UVR sensing apparatus, the ST sensing apparatus, and the solenoid, and configured to receive the UVR and ST signals when produced;
the controller further being configured to selectively control the solenoid to open the breaker in response to receipt by the controller of either of the UVR and ST signals.

2. The apparatus of claim 1 further comprising a solenoid driver operably connected to the controller, the solenoid having a drop-out threshold voltage, the solenoid driver being responsive to the selective control of the controller to reduce a voltage across the solenoid to a value at least as low as the drop-out threshold voltage.

3. The apparatus of claim 1 further comprising a solenoid driver operably connected to the solenoid, the solenoid having a drop-out threshold current, the solenoid driver being responsive to the selective control of the controller to reduce a current to the solenoid to a value at least as low as the drop-out threshold current.

4. The apparatus of claim 3 wherein the solenoid driver is a MOSFET driver circuit and the controller reduces current to the solenoid to a value at least as low as the drop-out threshold current by turning off the MOSFET.

5. The apparatus of claim 1 wherein the UVR sensing apparatus is configured to be connected to a line conductor of a circuit to be protected and to monitor a voltage in the conductor when the voltage is present.

6. The apparatus of claim 1 wherein the ST sensing apparatus is configured to be connected to a ST switch and to produce the ST signal in response to closure of the switch.

7. A protection apparatus for a circuit breaker disposed in a circuit to be protected, the protection apparatus comprising:
a solenoid configured to open the circuit breaker on command;
a controller connected to the solenoid and configured to issue an open command to the solenoid in response to receipt of either of an UVR signal and a ST signal;
an UVR sensing apparatus configured to be connected to a line conductor of the circuit to be protected and to monitor a line voltage of the circuit to be protected when carried by the line conductor, the UVR sensing apparatus further being connected to the controller and configured to produce an LVR signal in response to the line voltage falling below a predetermined level; and
an ST sensing apparatus configured to monitor for a ST command, the ST sensing apparatus further being connected to the controller and configured to produce an ST signal in response to sensing a ST command.

8. The apparatus of claim 7 wherein the ST sensing apparatus is further connected to a ST command bearing medium, the ST sensing apparatus monitoring the ST command bearing medium for an ST command.

9. The apparatus of claim 8 wherein the ST command bearing medium is a line conductor of the circuit to be protected.

10. The apparatus of claim 8 wherein the ST command bearing medium is a communications network.

11. The apparatus of claim 8 wherein the ST command bearing medium is a switch circuit.

12. The apparatus of claim 11 wherein the switch circuit is responsive to manual actuation of a button.

13. The apparatus of claim 7 wherein the solenoid is a hold open solenoid and the open command comprises lowering current through the solenoid below a drop-out threshold current of the solenoid.

14. The apparatus of claim 13 further comprising a solenoid driver connected and responsive to the controller and configured to provide current to the solenoid, the solenoid driver comprising a MOSFET, and reducing the current through the solenoid below the drop-out threshold current comprises turning off the MOSFET.

15. A circuit breaker accessory shunt trip (ST) and undervoltage voltage release (UVR) method comprising:
providing a solenoid configured and disposed to activate an operating mechanism of a circuit breaker in response to current in the solenoid falling below a predetermined level;
providing a microprocessor configured and disposed to selectively control current flow to the solenoid;
monitoring the circuit for UVR states and for ST states; and
selectively controlling current flow to the solenoid with the microprocessor in response to an undervoltage release state and in response to a shunt trip state.

16. The method of claim 15 wherein monitoring the circuit comprises monitoring a line voltage of the circuit and providing a first signal indicative of an UVR state to the controller.

17. The method of claim 15 wherein selectively controlling current flow in response to an UVR state includes detecting an UVR state by comparing a line voltage to a predetermined minimum voltage and determining that the line voltage is less than the predetermined minimum voltage.

18. The method of claim 15 further comprising providing a MOSFET operably connected to the microprocessor and selectively controlling current flow to the solenoid comprises selectively turning the MOSFET on and off.

19. The method of claim 18 wherein selectively controlling current flow comprises turning the MOSFET off.

20. The method of claim 15 wherein selectively controlling current flow in response to a shunt trip state includes detecting a shunt trip state by monitoring for a shunt trip command and determining that a shunt trip command has been detected.
